(19) United States
(12) Patent Application Publication
(10) Pub. No.: US 2011/0007913 A1
(43) Pub. Date: Jan. 13, 2011

(54) MAGNET ASSEMBLY FOR A LOUDSPEAKER

(75) Inventor: Soren Steen Nielsen, Aarhus (DK)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: SCANSPEAK A/S, Videbaek (DK)

(21) Appl. No.: 12/811,121

(22) PCT Filed: Jan. 6, 2009
(86) PCT No.: PCT/DK2009/050005

§ 371 Date: Sep. 17, 2010

(30) Foreign Application Priority Data
Jan. 7, 2008 (DK) PA 2008 00019

(51) Int. Cl. H04R 25/00; H01F 7/02; H04R 19/02; H04R 31/00

(52) U.S. Cl. 381/185; 335/302; 29/594

(57) ABSTRACT

The present invention relates to a magnet assembly (1) for a transducer unit of the type having a moving membrane and having a voice coil arranged into said magnet assembly, said magnet assembly comprising the components i) a T-yoke (2); and ii) a magnet system (4); and iii) a top plate (6). The magnet assembly according to the invention has a specific design which provides for improved characteristics as to strength of B field in the gap between the top plate and the T-yoke, as well as to homogeneity of the B field in the gap and degree of symmetry in the roll-off behaviour of the B field in either axially direction of the gap.

### FIELD OF THE INVENTION

The present invention relates to a magnet assembly for a transducer unit of the type having a moving membrane and having a voice coil arranged into said magnet assembly. Furthermore, the present invention relates to the use of such a magnet assembly for the manufacture of a loudspeaker. Additionally, the present invention relates to a method for the manufacture of a magnet assembly according to the present invention. Finally, the present invention relates to a loudspeaker comprising a magnet assembly according to the invention as well as a loudspeaker cabinet comprising such a loudspeaker.

### BACKGROUND OF THE INVENTION

In the art a number of different solutions to the construction of a magnet system have been suggested. When using magnet systems as drivers for generating the sound by moving the membrane it is customary to arrange a gap between two parts of the magnet system, so that there will be a magnetic flux field arranged across this gap. In the gap is arranged a voice coil which coil will due to an alternating current induced in the coil create a magnetic field which when arranged in the flux field of the magnet will make the coil move in the magnetic flux field substantially perpendicular to the direction of the flux lines making up the flux field.

In the art there are generally two types of designs, the first being overhung, where a relatively wide coil is arranged in a relatively narrow gap in such a way that the axially extension of the coil exceeds the axially extension of the gap. The other principle commonly applied is a so-called underhung system, where a relatively narrow coil is arranged in a relatively wide gap in such a way that the axially extension of the gap exceeds the axially extension of the coil.

The present invention relates in particular to a system of the underhung type, i.e. a system where the flux lines are present in a relatively wide gap influencing a relatively narrow coil in such a way that the axially extension of the gap exceeds the axially extension of the coil.

An example of a prior art loudspeaker assembly is disclosed in US 2002/0106101. This system comprises a driver unit comprising a central T-yoke, around which a permanent magnet is arranged. The construction provides a gap in which the voice coil may move almost at the periphery of the driver. Furthermore in order to save construction height the driver is partly arranged in front of the loudspeaker membrane, which will give rise to sound distortion, and a rather complicated design with respect to the fastening of the driver to the chassis.

Another prior art design is shown in FIG. 5. This design is represents an underhung system. The prior art design comprises a magnet assembly 100 comprising a T-yoke 102 on top of which is arranged a magnet 104. On top of the magnet 104 is arranged a top plate 106. The top plate 106 and the axially extending part of the T-yoke form a gap 108. In the prior art magnet assembly 100, the surface 110 of the top plate defining the outer surface of the rim and extending from a top rim 112 to a bottom rim 114 is essentially cylindrical in all its extension from its top rim 112 to its bottom rim 114, where the top plate touches the magnet 104.

A further example of a prior art design is known from WO 98/47312 wherein a magnet system is arranged in connection with a yoke construction. The gap in which the voice coil travels is arranged in the traditional manner as discussed above. This construction therefore also experiences problems resulting in distortion due to the magnetic flux roll of in either end (upper and lower) of the gap, due to magnetic flux concentration in these areas. Even in embodiments where a more gradual flux guide is provided, as for example illustrated in FIGS. 2 and 3, the difference in active cross-sectional area between the magnet and the gap is large, creating roll off effects as will be discussed below.

A prerequisite for a an accurate sound reproduction in a loudspeaker is that the sound waves produced by the moving membrane of the loudspeaker are as far as possible a true representation of the electrical waves supplied to the loudspeaker in the form of an electrical signal. A wide range of parameters influence the accuracy of the waveform of the produced sound waves. One important parameter which has a great influence on the degree of the accuracy of the produced sound is the degree of linearity between the electrical signal supplied to the loudspeaker and the axially movement of the membrane. Parameters influencing the accuracy in this movement of the membrane are at least two-fold. In order to obtain a high fidelity response by the membrane on the supplied electrical signal, the axially movement of the membrane should respond linearly to the electrical signal. In order to achieve such a linear response of the membrane, the magnetic flux in the gap in which the coil is accommodated must be as homogeneous as possible. The more homogeneous flux, the less distortion will result.

In addition it is important that the roll-off strength of the B-field is as symmetrical as possible, in that the curve representing the B-field as a function of the distance from the center of the gap should exhibit similar characteristics in either axially direction from the center of the gap. Hence, the curve representing the B-filed as a function of the distance from the center of the gap should as far as possible be symmetrical around the center of the gap at distances falling within the gap as well as at distances falling outside the gap. In this way, the so-called even-harmonic distortion can be reduced. Furthermore, having a symmetrical roll-off strength of the B-field outside the gap implies that the the coil may partly leave the gap without causing any unacceptable distortion.

In the prior art system shown in FIG. 5, a somewhat acceptable homogeneous magnetic flux in the gap 108 in which the coil is accommodated can been obtained. However, there exists a continuing need for improving the homogeneity of the magnetic flux of the gap of such a magnet assembly and at the same time provide for a more symmetrical roll-off B-field in order to provide for a more accurate sound reproduction. Furthermore this design results in very large magnet systems, adding considerable weight to the loudspeaker, sometimes exceeding the outer diameter of the speaker which makes this underhung design an impractical choice.

### OBJECT OF THE INVENTION

It is the object of the present invention to provide a magnet assembly of the type having a moving membrane and having a voice coil arranged into said magnet assembly, wherein the performance of the magnet system is improved. The improvement is mainly directed at creating a homogenous magnetic flux in the gap intended for the accommodation of the voice coil and providing a magnet system which even after extended continuous use has less distortion of the sound and at the same time provides a very compact design which due to its space and weight saving properties in relation to its output effect provides for an improved magnet system, wherein the magnet assembly at the same time provides for a more symmetrical roll-off magnetic field in respect of the two opposite axially directions from the center of the gap.

### DESCRIPTION OF THE INVENTION

This object is achieved by the present invention which in a first aspect relates to a magnet assembly (1) for a transducer unit of the type having a moving membrane and having a voice coil arranged into said magnet assembly, said magnet assembly comprising the components i)-iii):

i) a T-yoke (2); and

ii) a magnet system (4); and

iii) a top plate (6);

wherein the T-yoke (2) comprises a body comprising a pole part (8) defining a cylindrical, outer surface (10) which is symmetrical around an axis of rotation, said cylindrical surface has an outer diameter d₁ and a cylinder rim (11); wherein in the orientation in which the axis of rotation of the cylindrical surface (10) is vertical and in which the cylinder rim (11) points upwards, the T-yoke (2) furthermore comprises:
a back plate (12) comprising a bottom surface (14); said bottom surface (14) at its bottom rim (16) extends outwards and upwards so as to define an outer back plate surface (18) which ends in an outer rim (20), wherein said back plate (12) furthermore comprises an accommodation surface (22) for a magnet system, said accommodation surface (22) for a magnet system extending essentially in a horizontal direction inwards from the outer rim (20) to an inner rim (24), wherein said accommodation surface (22) for a magnet system is essentially symmetrical around the axis of rotation of the cylindrical surface (10); and
wherein said magnet system (4) is an annular body having a top surface (26), a bottom surface (28); wherein the top surface (26) is essentially parallel to the bottom surface (28), and wherein the dimensions of the magnet system (4) in the radial direction are adapted so as to be able to fit onto the accommodation surface (22) of the T-yoke (2); and
wherein the top plate (6) comprises an annular body comprising an upper, inner surface (36) which is essentially cylindrical and symmetrical around an axis of rotation, said upper, inner surface (36) extends from an upper, inner rim (38) to a lower, inner rim (40); and said upper, inner surface (36) having a diameter d₂; wherein in the orientation in which the axis of rotation of the cylindrical surface (36) is vertical and in which the rim (38) points upward, the top plate furthermore comprises: a lower, inner surface (42) extending downwards and outwards from the lower, inner rim (40) to a bottom inner rim (44); a bottom surface (46) extending from the bottom inner rim (44) to a bottom, outer rim (48b); said bottom surface (46) being essentially horizontal; an outer surface (50) extending upwards and preferably inwards from a bottom, outer rim (48,48a) to an upper, outer rim (52); and a top surface (54) extending from the upper, outer rim (52) to the upper, inner rim (38); wherein dimensions of the bottom surface (46) are adapted so as to be able to fit onto the top surface (26) of the magnet system (4);
characterised in that the diameter d₁ is smaller than the diameter d₂; and in that the top plate (6) is arranged on top of the magnet system (4) in such a way that the bottom surface (46) of the top plate (6) touches the top surface (26) of the magnet system (4), and in that the magnet system (4) is arranged on top of the T-yoke (8) in such a way that the bottom surface (28) of the magnet system (4) touches the accommodation surface (22) of the T-yoke (8); and in that the difference between the diameter d₁ and d₂ defines a gap (56) between the cylindrical, outer surface (10) of the T-yoke and the upper, inner surface (36) of the top plate so as to be able to accommodate a voice coil.

The present invention relates in a second aspect to a method for the manufacture of a magnet assembly according to the present invention, by assembling a T-yoke (2), a magnet system (4), and top plate (6); wherein the flux density in the gap (56) of the magnet assembly (1) is predetermined by the choice of the extent in an axially direction of the surface (36) of the top plate.

The present invention relates furthermore in a third aspect to the use of a magnet assembly according to the present invention for the manufacture of a loudspeaker.

Additionally, the present invention relates in a fourth aspect to a loudspeaker comprising a magnet assembly (1) according to the present invention wherein a voice coil is accommodated into the gap (56) defined by the space between the outer surface (10) of the T-yoke and the upper, inner surface (36) of the top plate; and wherein the magnet assembly (1) is suspended in a chassis and wherein a membrane is suspended between the voice coil and the chassis.

Finally in a fifth aspect the present invention relates to a loudspeaker cabinet comprising a loudspeaker according to the present invention.

### DESCRIPTION OF THE DRAWING

FIG. 1 shows a vertical cross section of the T-yoke comprised in the magnet assembly of the present invention.

FIG. 2a shows a vertical cross section of a preferred embodiment of the magnet system in the form of a one-part annular body comprised in the magnet assembly of the present invention.

FIG. 2b shows a horizontal cross section of another embodiment of the magnet system in the form of an array of disc shaped magnets comprised in the magnet assembly of the present invention.

FIG. 3a shows a vertical cross section of the top plate comprised in the magnet assembly of the present invention.

FIG. 3b shows a vertical cross section of an alternative design of the top plate comprised in the magnet assembly of the present invention.

FIG. 4 shows a vertical cross section of an assembled magnet assembly according to the present invention.

FIG. 5 shows a vertical partly cross section of an assembled magnet assembly according to the prior art. Only “right hand side” of the cross-section of the magnet assembly is shown.

FIG. 6a-6d illustrates a variety of vertical partly cross-sections preferred designs of the top plate comprised in the magnet assembly of the present invention. Only “right hand side” of the cross-section of the annular top plate is shown.

FIG. 7 shows cuves of the B-field in the gap as a function of the distance from the center of the gap in respect to a range of different magnet assembly designs depicted in FIG. 8a-8d. The results were obtained by a simulation experiment.

FIG. 8a-8d show the different designs of top plates and magnet assemblies used to obtain the simulation results depicted in FIG. 7.

### DETAILED DESCRIPTION OF THE INVENTION

### The Magnet Assembly According to the Present Invention

In a first aspect the present invention relates to a magnet assembly 1 for a transducer unit of the type having a moving membrane and having a voice coil arranged into said magnet assembly, said magnet assembly comprising the components i)-iii):

i) a T-yoke 2; and

ii) a magnet system 4; and

iii) a top plate 6;

wherein the T-yoke 2 comprises a body comprising a pole part 8 defining a cylindrical, outer surface 10 which is symmetrical around an axis of rotation, said cylindrical surface has an outer diameter d₁ and a cylinder rim 11; wherein in the orientation in which the axis of rotation of the cylindrical surface 10 is vertical and in which the cylinder rim 11 points upwards, the T-yoke 2 furthermore comprises:
a back plate 12 comprising a bottom surface 14; said bottom surface 14 at its bottom rim 16 extends outwards and upwards so as to define an outer back plate surface 18 which ends in an outer rim 20, wherein said back plate 12 furthermore comprises an accommodation surface 22 for a magnet system, said accommodation surface 22 for a magnet system extending essentially in a horizontal direction inwards from the outer rim 20 to an inner rim 24, wherein said accommodation surface 22 for a magnet system is essentially symmetrical around the axis of rotation of the cylindrical surface 10; and
wherein said magnet system 4 is an annular body having a top surface 26, a bottom surface 28; wherein the top surface 26 is essentially parallel to the bottom surface 28, and wherein the dimensions of the magnet system 4 in the radial direction are adapted so as to be able to fit onto the accommodation surface 22 of the T-yoke 2; and
wherein the top plate 6 comprises an annular body comprising an upper, inner surface 36 which is essentially cylindrical and symmetrical around an axis of rotation, said upper, inner surface 36 extends from an upper, inner rim 38 to a lower, inner rim 40; and said upper, inner surface 36 having a diameter d₂; wherein in the orientation in which the axis of rotation of the cylindrical surface 36 is vertical and in which the rim 38 points upward, the top plate furthermore comprises: a lower, inner surface 42 extending downwards and outwards from the lower, inner rim 40 to a bottom inner rim 44; a bottom surface 46 extending from the bottom inner rim 44 to a bottom, outer rim 48,48b; said bottom surface 46 being essentially horizontal; an outer surface 50 extending upwards and preferably inwards from a bottom, outer rim 48,48a to an upper, outer rim 52; and a top surface 54 extending from the upper, outer rim 52 to the upper, inner rim 38; wherein dimensions of the bottom surface 46 are adapted so as to be able to fit onto the top surface 26 of the magnet system 4;
wherein the diameter d₁ is smaller than the diameter d₂; and wherein the top plate 6 is arranged on top of the magnet system 4 in such a way that the bottom surface 46 of the top plate 6 touches the top surface 26 of the magnet system 4, and wherein the magnet system 4 is arranged on top of the T-yoke 8 in such a way that the bottom surface 28 of the magnet system 4 touches the accommodation surface 22 of the T-yoke 8; and wherein the difference between the diameter d₁ and d₂ defines a gap 56 between the cylindrical, outer surface 10 of the T-yoke and the upper, inner surface 36 of the top plate so as to be able to accommodate a voice coil.

The magnet assembly according to the invention has a design that provides for a more homogeneous magnetic flux in the gap 56 in which the voice coil is to be accommodated. Furthermore, the magnet assembly according to the present invention provides for a more symmetrical roll-off behaviour of the B field in either axially direction outside the gap. Such symmetry is responsible for a reduction in the even-harmonic distortion. Additionally, the magnet assembly according to the present invention provides for a more homogeneous saturation of the material of the top plate, which again is responsible for a reduced distortion. Finally, the magnet assembly according to the present invention provides for a reduction in the stray flux, which obviously results in a more efficient utilisation of the magnetic flux field of the magnet.

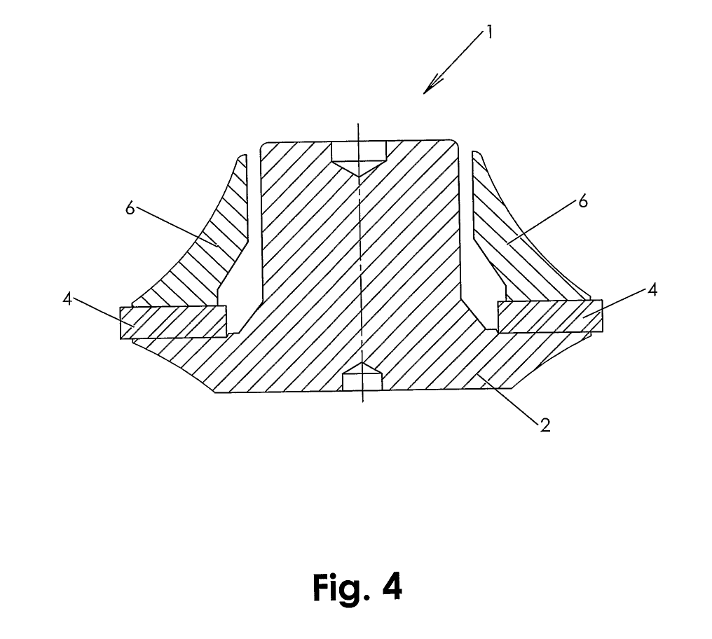

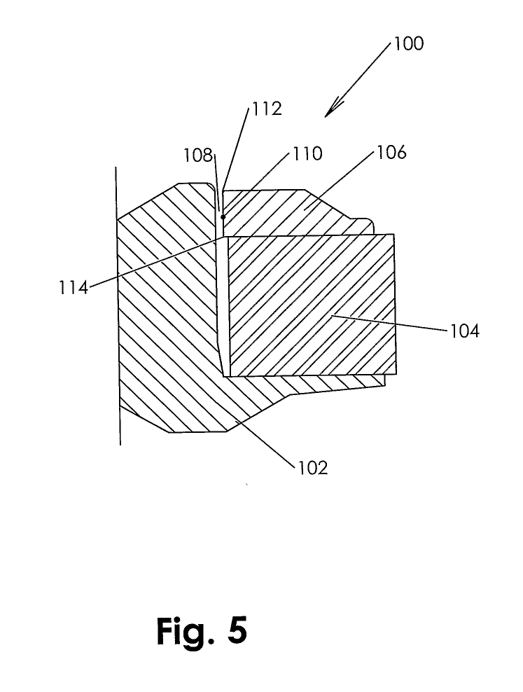

In the present description and the appended claims the specific features of the T-yoke 2, the magnet system 4 and the top plate 6 of the magnet assembly are referred to in the orientation in which the magnet system is arranged on top of the T-yoke, and in which the top plate is arranged on top of the magnet system, and in which orientation the axis of rotation of the cylindrical surfaces of the T-yoke and the top plate is vertical. Such an orientation is seen in FIG. 4.

### The T-Yoke of the Magnet Assembly According to the Present Invention

The T-yoke 2 of the magnet assembly of the present invention comprises a body comprising a pole part 8 defining a cylindrical, outer surface 10 which is symmetrical around an axis of rotation, said cylindrical surface has an outer diameter d₁ and a cylinder rim 11, wherein in the orientation in which the axis of rotation of the cylindrical surface 10 is vertical and in which the cylinder rim 11 points upwards, the T-yoke 2 furthermore comprises: a back plate 12 comprising a bottom surface 14; said bottom surface 14 at its bottom rim 16 extends outwards and upwards so as to define an outer back plate surface 18 which ends in an outer rim 20, wherein said back plate 12 furthermore comprises an accommodation surface 22 for a magnet system, said accommodation surface 22 for a magnet system extending essentially in a horizontal direction inwards from the outer rim 20 to an inner rim 24, wherein said accommodation surface 22 for a magnet system is essentially symmetrical around the axis of rotation of the cylindrical surface 10.

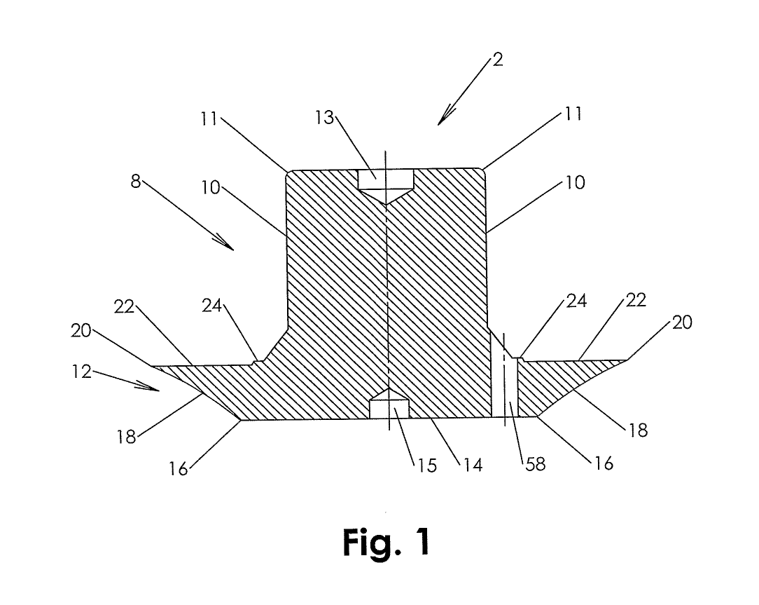

FIG. 1 shows a cross sectional view of the T-yoke of the magnet assembly of the present invention.

The outer surface 10 of the pole part forms one surface of the gap 56. The other surface of the gap 56 being formed by the top plate. Hence, the diameter d₁ of the surface 10 determines the lower limit of the diameter of the voice coil to be accommodated in the gap 56. The magnet assembly according to the present invention is particularly intended for a loudspeaker of the underhung type. Therefore, it is preferred that the cylindrical surface 10 of the T-yoke has an extension in an axially direction which exceeds the axially extension of the voice coil intended for use with the T-yoke of the magnet assembly.

Opposite to the pole part 8 of the T-yoke is the back plate 12. The back plate 12 comprises a bottom surface 14. This surface can have a variety of different shapes. In one preferred embodiment the bottom surface 14 is planar. The outer rim of the bottom surface 14 is defined by the bottom rim 16. It is preferred that this bottom rim 16 is circular. The back plate 12 extends from the bottom rim 16 upward and outward to the outer rim 20. The back plate 12 furthermore comprises an accommodation surface 22 extending from the outer rim 20 to the inner rim 24. The accommodation surface 22 is planar and arranged in a horizontal plane. The accommodation surface 22 is intended to accommodate a magnet system as described below. Preferably the accommodation surface 22 is circular so as to define a surface which is symmetrical around an axis of rotation.

The T-yoke is preferably made of a material of a high magnetic permeability, preferably low-alloy steel (soft iron).

Preferably the T-yoke is made from a chunk of material by turning/milling off any excessive material in a lathe. Alternatively it may be manufactured by cold forging and successive machining to desired finish.

In one embodiment it is preferred that the T-yoke is itself composed of two pieces, viz. a) a pole piece comprising a body extending from the central part of the bottom surface 14 in an axially direction upwards so as to define a body which is symmetrical around an axis of rotation; and b) a backplate piece comprising a body defined by an outer part of the bottom surface 14, the back plate surface 18, and the accommodation surface 22. In such a two-part arrangement of the T-yoke, the pole piece of the T-yoke and the back plate piece of the T-yoke are preferably fixed to each other by glue, such as epoxy or hydroxy methacrylate glue.

The two-piece arrangement of the T-yoke provides cost savings in materials because a less amount of milled-off waste material will be produced. Such cost savings is especially encountered in situations in which the T-yoke is manufactured by turning/milling, i.e. in cases without a previously cold forging step.

### The Magnet System of the Magnet Assembly

The magnet system 4 of the magnet assembly of the present invention comprises an annular body having a top surface 26, a bottom surface 28; wherein the top surface 26 is essentially parallel to the bottom surface 28, and wherein the dimensions of the magnet system 4 in the radial direction are adapted so as to be able to fit onto the accommodation surface 22 of the T-yoke 2.

As set out above the magnet system of the magnet assembly comprises an annular body which is to be arranged on top of the accommodation surface 22 of the T-yoke. Hence, the extent in a radial direction of the magnet system 4 and the accommodation surface 22 must be adapted to one another so that the magnet system 4 fits well onto the accommodation surface 22 of the T-yoke.

The magnet system 4 of the magnet assembly of the present invention comprises a magnetic material of neodymium, ferrite, samarium-cobalt AlNiCo or comprises another type of a hard magnetic material which is conventionally and/or traditionally used as magnetic material. This design lends itself to the use of high energy product magnet materials and in particular materials characterized in a high coercivity, but is not limited to this group of hard magnetic materials.

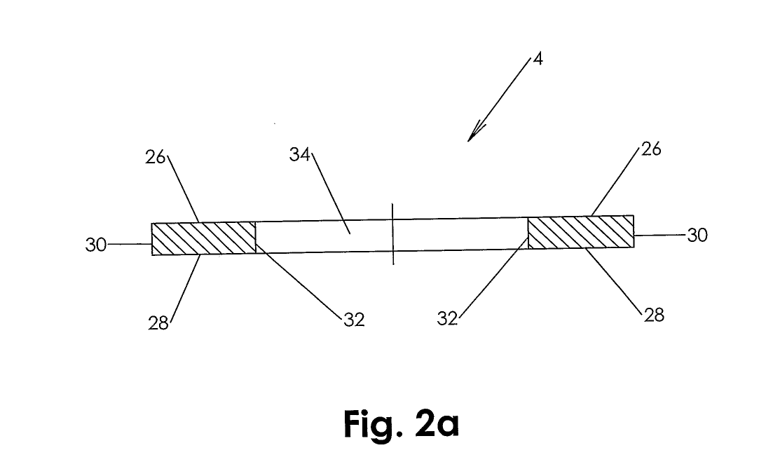

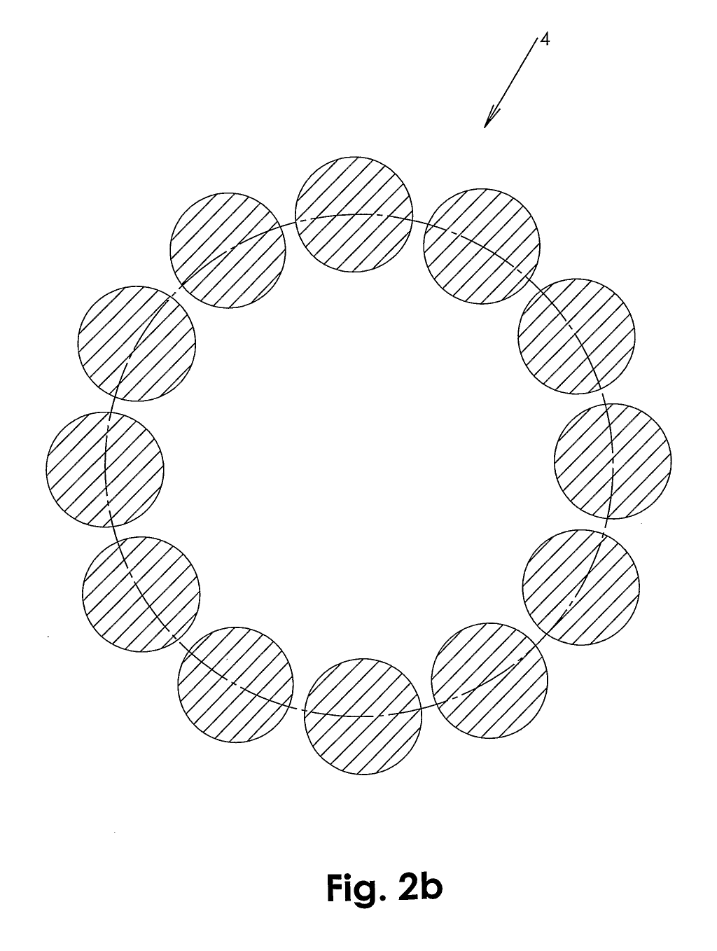

In one embodiment of the present invention, the magnet system 4 is in one piece. This one-piece magnet system comprises an annular body of a magnetic material which annular body comprising a top surface 26, a bottom surface 28; an outer surface 30 and having a central hole 34 defined by an inner surface 32; wherein the inner surface 32 as well as the outer surface 30 are cylindrical; wherein the outer surface 30 and the inner surface 32 are essentially perpendicular to the surfaces 26 and 28. FIG. 2a shows a vertical cross-section of such a magnet system.

In another embodiment of the present invention, the magnet system 4 comprises a body comprised of an array of disc shaped magnets having identical dimensions and together defining a top surface 26, a bottom surface 28, wherein the centre of each disc shaped magnet of said array is arranged with essentially equal mutual spacing on a circle. Such a magnet system of an array of distinct magnets provides for cost savings in the manufacture of the magnet assembly according to the present invention without compromising the quality of the final magnet assembly. FIG. 2b shows a horizontal cross-section of such a magnet system.

In yet another embodiment, the magnet assembly according to the present invention is designed in such a way that the extension of the magnet system in a radial direction exceeds the extension in a radial direction of the surface 46 of the top plate and/or exceeds the extension in a radial direction of the accommodation surface 22 of the yoke.

In another preferred embodiment, the magnet assembly according to the present invention further comprising a fourth component comprising a booster magnet arranged on top of the pole part 8 of the T-yoke. As the name indicates such a booster magnet can participate in providing the high strength magnetic flux required in the gap 56 of the magnet assembly. The booster magnet is preferably a disc shaped or annular body shaped magnet which is symmetrical around an axis of rotation.

### The Top Plate of the Magnet Assembly

The top plate 6 of the magnet assembly according to the present invention comprises an annular body comprising an upper, inner surface 36 which is essentially cylindrical and symmetrical around an axis of rotation, said upper, inner surface 36 extends from an upper, inner rim 38 to a lower, inner rim 40; and said upper, inner surface 36 having a diameter d₂; wherein in the orientation in which the axis of rotation of the cylindrical surface 36) is vertical and in which the rim 38 points upward, the top plate furthermore comprises: a lower, inner surface 42 extending downwards and outwards from the lower, inner rim 40 to a bottom inner rim 44; a bottom surface 46 extending from the bottom inner rim 44 to a bottom, outer rim 48,48b; said bottom surface 46 being essentially horizontal; an outer surface 50 extending upwards and preferably inwards from a bottom, outer rim 48,48a to an upper, outer rim 52; and a top surface 54 extending from the upper, outer rim 52 to the upper, inner rim 38; wherein dimensions of the bottom surface 46 are adapted so as to be able to fit onto the top surface 26 of the magnet system 4.

The outer surface 36 of the top plate forms the other surface of the gap 56. The first surface of the gap 56 being formed by the pole part of the T-yoke. Hence, the diameter d₂ of the surface 36 determines the higher limit of the diameter of the voice coil to be accommodated in the gap 56.

In one embodiment of the top plate of the magnet assembly of the present invention, the bottom, outer rim 48b has a lower position than the bottom, outer rim 48a in such a way that these two rims 48a,48b define between them a surface 49. In another embodiment of the top plate of the magnet assembly of the present invention, the bottom, outer rim 48b is the same rim as the bottom, outer rim 48a. In this case, there is no interposing surface 49.

The feature that the lower, inner surface 42 extends downwards and outwards from the lower, inner rim 40 to a bottom inner rim 44 is an essential feature of the magnet assembly of the present invention in that it has been found that the presence of an inclined—relative to vertical—inner surface 42 provides for a more symmetric roll-off behaviour at either axially end of the air gap—as illustrated with simulation 8b compared to simulation 8a, 8c and 8d in the example below.

In a preferred embodiment of the magnet assembly according to the present invention, the outer surface 50 of the top plate in a direction from a point on the rim 48,48a to the nearest point on the rim 52 defines a concave curve.

In another preferred embodiment of the magnet assembly according to the present invention the lower, inner surface 42 of the top plate in a direction from a point on the rim 44 to the nearest point on the rim 40 defines a concave curve, a straight line or a convex curve.

In yet another embodiment of the magnet assembly according to the present invention, the outer surface 50 of the top plate in a direction from a point on the rim 48,48a to the nearest point on the rim 52 defines a convex curve

In still another embodiment of the magnet assembly according to the present invention the lower, inner surface 42 of the top plate in a direction from a point on the rim 44 to the nearest point on the rim 40 defines a concave curve.

It is preferred that the lower, inner surface 42 of the top plate comprises at least a partial surface 42a, said partial surface 42a defines a curve in such a way that the shortest distance between any point on the surface 42a and the outer surface 50 in a horizontal direction is essentially constant. In this embodiment it is possible in the part of the top plate associated with the partial surface 42a to provide an essentially constant minimum cross sectional area for the magnetic flux in order to maintain at constant flux density.

Such a design provides for a homogeneous saturation of the top plate. In this configuration the outer surface of the top plate will furthermore deflect any waves into different directions and thereby confuse the wave energy. In this manner minimal direct reflection back on the membrane is assured, which results in less distortion. In this connection the cooperation with the chassis into which the magnet system and membrane are arranged is also important.

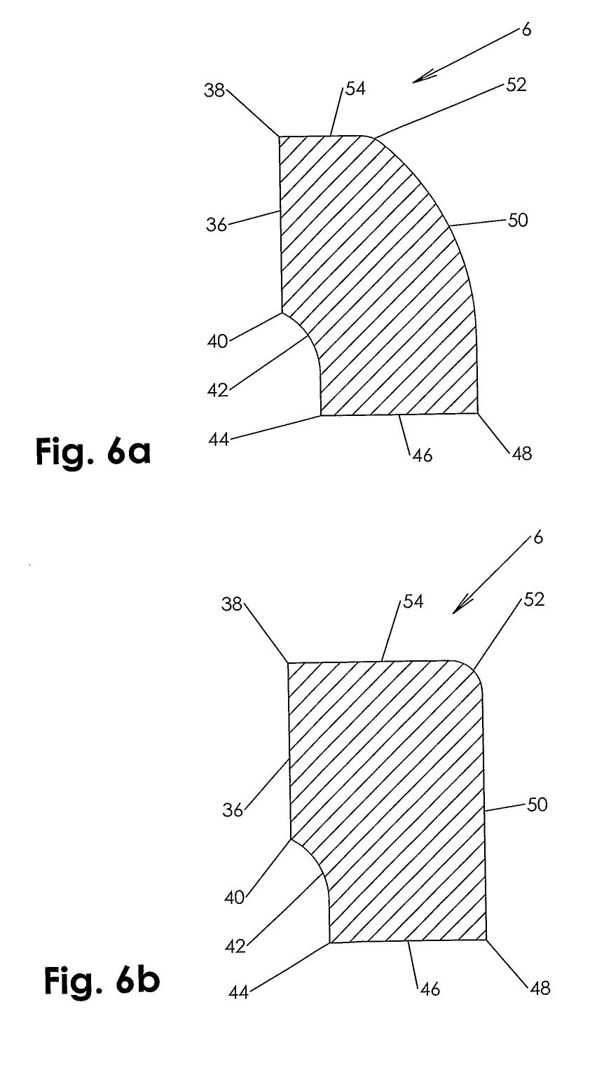

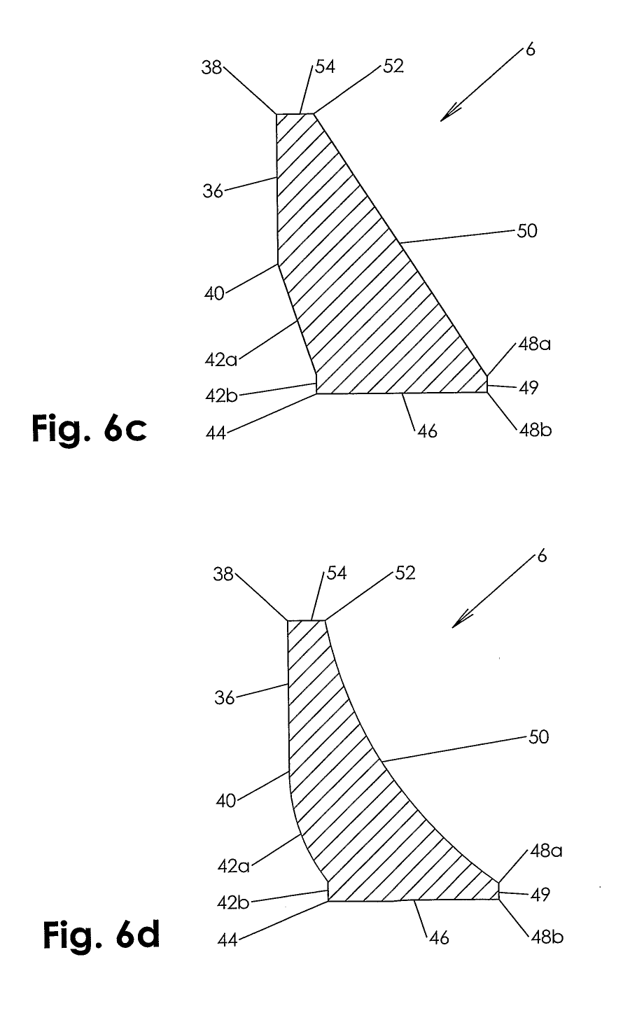

FIG. 6a-6d show partly cross-sections of different preferred designs of the top plate of the magnet assembly according to the present invention. In FIG. 6a the top plate comprises a convex outer surface 50 and a concave lower, inner surface 42. In FIG. 6b, the outer surface extends essentially vertically upwards from the bottom, outer rim 48 to the upper, outer rim 52. FIGS. 6c and 6d each show a top plate in which the lower, inner surface 42 comprises an upper partial surface 42a, in which said partial surface 42a defines a curve in such a way that the shortest distance between any point on the surface 42a and the outer surface 50 in a horizontal direction is essentially constant.

### Conductive Layers

In a preferred embodiment of the magnet assembly of the present invention, the cylindrical, outer surface 10 of the T-yoke and/or the upper, inner surface 36 of the top plate is/are provided with a layer of a conductive material, said layer extends axially in a length at least corresponding to the axial length of the gap 56.

The conductive layer will to a certain extent dampen the flux intensity, but also to a certain extent dampen the effect of the magnetic field lines. This is mainly due to the added distance between the soft iron parts of the system on either side of the gap. Therefore, the intention is to provide a very thin conductive layer on both surfaces in such a way that the distance between the conductive layers defines the gap. This implies that on both sides of the gap substantially symmetrical conditions on either part, i.e. the T-yoke and the top plate is provided so that a substantially homogeneous magnetic field is present in the gap.

The provision of a conductive layer in the gap will short-circuit any eddy-currents generated in the magnet assembly by applying electrical current to the voice coil. For the same reasons, i.e. to minimise the eddy-currents the voice coil former may be made from a non-conductive material such as titanium or glass fibre.

Additionally, the conductive layer in particular when it is of copper or other heat conducting material will guide heat away from the gap. In this manner there will be less thermal load on the voice coil which again causes less distortion. This is particularly important in the embodiment of the invention where the magnet arranged between the T-yoke and the top plate is a neodymium magnet because neodymium magnets are known to have a lower temperature tolerance before demagnetization will occur.

The conductive layer present in the system together with the symmetry of this conducting layer positioned in the magnet system according to the invention will furthermore lower the self-induction, in particular in relation to the amplitude (high/low).

The symmetry is also a factor when determining the conducting layers on the T-yoke and the top plate respectively. The radius of the conducting layer of the pole part 10 of the T-yoke is smaller than the radius of the conducting layer of the inner surface 36 of the top plate. Therefore when the layers have the same thickness, typically 0.2 mm, the conducting layer of the T-yoke shall extend a little longer than the conducting layer of the top plate, whereby a symmetrically amount of conducting layer will be present in the voice coil's working zone, where self induction may be generated.

The permanent magnet system is creating a static magnet field, whereas the alternating current (the music signal) in the voice coil creates a dynamic field. These currents are in opposite directions, which results in a dampening effect of the voice coils movement up and down. When these magnetic fields interact a fluxmodulation occurs. The conducting layers, as described above, reduce this phenomena. Eddy-currents occur in electrically conductive materials such as iron parts in the magnet system. The conducting layers also reduce the dampening effect caused by eddy-currents in the iron parts, located in the gap. Furthermore the conducting layers also reduce the self-inductance in the voice coil. This is mainly achieved by the conducting layer of the surface 10 of the T-yoke and partially by the conductive layer of the surface 36 of the top plate.

The conducting layer serves to create a counterflux to reduce the total flux stemming from the dynamic field and to reduce self-induction of the voice coil. The thicker the conducting layer, the better the short circuit effect on high currents results in improved low frequence performance, but at the same time, a thicker conducting layer also dampens the magnetic field due to the longer distance between the iron parts in the gap. The magnetic field is important in that as an electrical current is passed through the windings on the voice coil arranged in the gap of a typical loudspeaker of this type, fluctuations in the current will react to the magnetic flux lines in a direction perpendicular to the flux-line and thereby move the coil parallel to the axis of symmetry so that a sound may be generated by a membrane either attached to the voice coil or integrated with a voice coil. For these reasons it is important to have a substantially homogenous magnetic field present in the gap, and at the same time a magnetic field which is not dampened so that it is necessary to provide a larger/stronger magnet in connection with the pieces defining the gap.

It is preferred that the conductive layer of the surface 10 extends a little bit beyond the rim 11 so as to cover also an outer rim of the axially end of the pole part 8 of the T-yoke 2.

Likewise, it is preferred that the conductive layer of the surface 36 of the top plate extends a little bit beyond the rim 38 so as to cover also part of or the whole of surface 54 of the top plate.

It is preferred that the conductive layer is selected from the group comprising copper, silver, aluminium, platinum and gold.

In a preferred embodiment, the thickness of the layer is 0.1-0.7 mm, such as 0.15-0.6 mm, for example 0.18-0.32 mm.

### Other Features of the Magnet Assembly of the Present Invention

As set out above, the difference between the diameter d₂ of the inner surface 36 of the top plate and the diameter d₁ of the outer surface 10 of the pole part of the T-yoke defines a gap having an extension in the radial direction which is ½*(d₂−d₁).

It is preferred that the distance ½*(d₂−d₁) is 0.5-3.0 mm, e.g. 0.75-2.0 mm, such as 1.0-1.8 mm. Whether or not conducting layers are provided on the T-yoke and/or on the top plate, the gap distance is the ½*(d₂−d₁), wherein d₂ and d₁ being the diameter of the surface 36 of the top plate and the diameter of the pole part respectively, with or without conducting layers as the case may be.

In a preferred embodiment of the magnet assembly of the present invention, the back plate 12 of the T-yoke 2 and the top plate 6 comprise axially arranged holes 58. Such holes may either serve to accommodate bolts for bolting together the assembly or may serve as cooling and/or venting channels. It is preferred that such holes 58 are being located on a circle having a diameter which is greater than d₁.

In the case of a multiple disc magnet system design these holes 58 may also be present where there are gaps between the discs, such as would be the case by using e.g. round disc magnets.

Tests have indicated that the provision of ventilation holes 58 in the T-yoke does not influence the homogeneity of the magnetic flux lines in the T-yoke or the top plate. Although it is advantageous to avoid holes in the T-yoke in order to attain as homogeneous a saturation of the iron-core pole part as possible, tests have indicated, that ventilation holes 58 do not have a detrimental effect on this and that for normal use with the dimensions mentioned above, 1.6 Tesla is present in the soft iron parts of the system.

The ventilation holes 58 mainly serve two purposes, namely to allow the hot air which may be generated due to the provision of a neodymium magnet being exposed to a voice coil. Having the ventilation holes 58 allows the warm/hot air to escape so that the temperature inside the space confined by the T-yoke, the magnet and the top plate may be kept as low as possible, whereby distortion of the generated sound is minimized. Furthermore, the ventilation holes 58 serve to avoid an air pressure building up in the gap by virtue of the movement of the membrane which could hamper the movement of the voice coil in the gap.

In FIG. 4 is shown a cross-sectional view of the assembled magnet assembly according to the present invention. Inside the assembly air can be trapped in a cavity confined by the T-yoke, the one-piece magnet and the top plate. Although it is possible for air to escape through the gap 56, the gap 56 will under normal circumstances be substantially filled with a moving voice coil. The air trapped inside the cavity may due to the generation of heat by the magnet and voice coil as explained above create an air cushion which will dampen the voice coil's ability to move up and down. Therefore, by providing the ventilation holes 58 this effect is avoided. As the ventilation holes 58 are provided relatively far from the gap 56, the apertures do not influence the homogeneity of the magnetic flux field in the gap in that the magnetic flux lines travelling through the T-yoke will be able to distribute around the ventilation hole 58 and thereby create a magnetic flux field which is substantially homogenous in the gap.

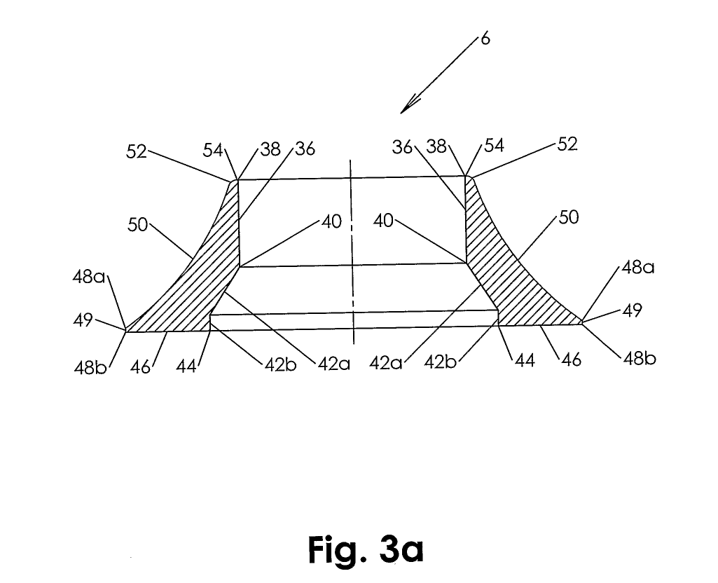

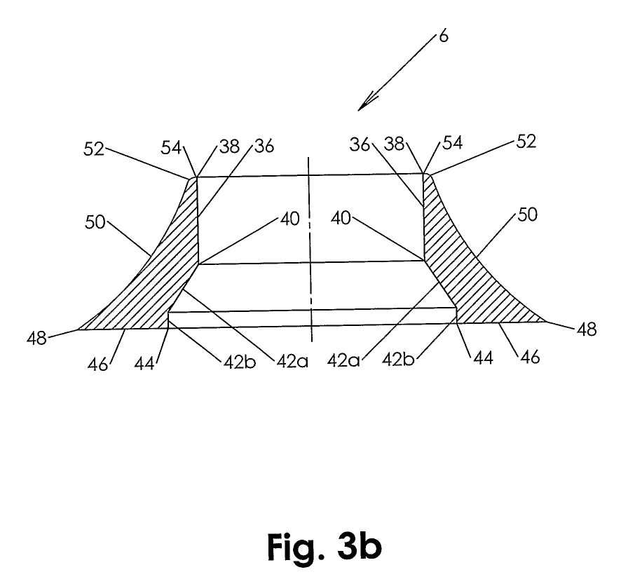

In FIG. 1, FIGS. 3a and 3b the rims 11 and 52 of the T-yoke and the top plate respectively are depicted as fairly sharp. Such depiction should not be taken literally. In fact, it may be advantageous that the rims 11 and 52 of the T-yoke and the top plate respectively have a more rounded appearance. This has the effect that hot-spots, i.e. points where a concentration of flux lines may occur which could be detrimental to the effect of the magnetic field created in the gap, are avoided. In this manner it is foreseen that the magnetic field and thereby the flux lines in the gap 56 are homogenously distributed throughout the gap and are substantially perpendicular to the axis of symmetry 10 at least inside the gap.

In fact such rounded rims may be advantageous in respect of other rims than the rims 11 and 52 of the T-yoke 2 and the top plate respectively as described above. The same applies in respect of the rim 20 of the T-yoke 2, which preferably also has a rounded appearance. Also, such rounded rims provides easy handling of the specific parts during manufacture and assembling of the parts because the parts becomes less prone to deformation upon impact. Hence, in the present description and the appended claims, the term “rim” should be interpreted as a borderline defining a clearly visible transition between two surfaces having different spatial orientations.

Apertures 13,15 (see FIG. 1) may optionally be provided in the T-yoke 2. The aperture 13 may be used to fasten a cone, plug or the like in order to, in cooperation with the membrane distribute the sound depending on which type of loudspeaker the magnet assembly is used with. Likewise, the aperture 15 may be used in order to fasten the magnetic system to a chassis or the like.

Furthermore, the apertures 13,15 may extent all the way through the T-yoke 2 in an axially direction, thereby making the T-yoke hollow.

### A Process for the Manufacture of the Magnet Assembly According to the Present Invention

The present invention relates in a second aspect to a method for the manufacture of a magnet assembly 1 according to any of the present invention. The process involves assembling a T-yoke 2, a magnet system 4, and top plate 6; wherein the flux density in the gap 56 of the magnet assembly 1 is predetermined by the choice of the extent in an axially direction of the surface 36.

Such a process is commercially very attractive in that by stocking standard supplies of a T-yoke, a magnets system and a top plate, specific needs as to density of magnetic flux in the gap can be met simply by first modifying the axially extent of the inner surface 36 of the top plate to an extent corresponding to the required specific magnetic flux density of the gap; and subsequently assembling stock supplies of the T-yoke, the magnet system and the modified stock supply of the top plate.

Hence, a wide variety of magnet assemblies exhibiting different magnetic flux densities in the gap can easily and extremely cost beneficially be made from stock supplies simply by modification of only one component of the magnet assembly.

The magnet system—whether in the form of a one-piece annular magnetic body or in the form of an array of separate disc shaped magnets—are available in standard sizes at suppliers of magnetic materials.

The T-yoke and the top plate are preferably made by first cold forging a lump of the desired metal or alloy into a shape of increased similarity with the intended product and subsequently turning and/or milling off excessive material in a lathe. The above process can be automated as it is well known in the art of metal working.

### Use of the Magnet Assembly for the Manufacture of a Loudspeaker

In a third aspect the present invention relates to the use of a magnet assembly according to the present invention for the manufacture of a loudspeaker.

### A Loudspeaker Comprising the Inventive Magnet Assembly

In a fourth aspect the present invention relates to a loudspeaker per se. The loudspeaker comprises a magnet assembly according to the present invention. A voice coil is accommodated into the gap 56 defined by the space between the outer surface 10 of the T-yoke and the upper, inner surface 36 of the top plate. Furthermore, the magnet assembly 1 is suspended in a chassis and a membrane is suspended between the voice coil and the chassis.

A person skilled in the art of building loudspeaker will know how to assemble a loudspeaker comprising the magnet assembly according to the present invention.

In a preferred embodiment, the loudspeaker of the present invention is of the underhung type, wherein the voice coil has an extention in an axially direction which is smaller than the axial extension of the gap 56 defined by the space between the outer surface 10 of the T-yoke and the upper, inner surface 36 of the top plate.

In another preferred embodiment of the loudspeaker according to the present invention, the loudspeaker is a subwoofer speaker, a woofer speaker, a woofer-midrange speaker, midrange speaker, a tweeter speaker or a fullrange speaker.

### A Loudspeaker Cabinet Comprising a Loudspeaker According to the Invention

In a fifth aspect the present invention relates to a loudspeaker cabinet per se.

A person skilled in the art of building loudspeaker will know how to assemble a loudspeaker cabinet comprising the loudspeaker according to the present invention.

### EXAMPLE

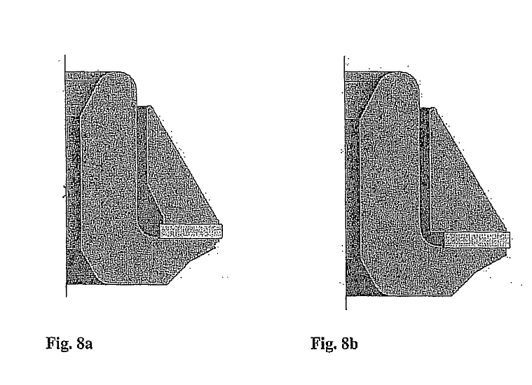

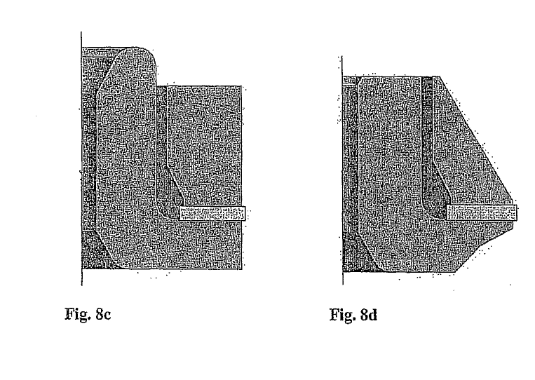

The applicant has made a range of simulations of the flux in the gap of magnet assemblies of different geometries. FIGS. 8a-8d show representations of four of these geometries. FIGS. 8a, 8c and 8d are all geometries in accordance with the magnet assembly of the present invention. It is clearly seen in FIGS. 8a, 8c and 8d that the curve 42 extends downward and outward from the lower inner rim 40 of the top plate to the bottom inner rim 44 of the top plate. This is not the case in respect of the assembly geometry depicted in FIG. 8b, in which the upper inner surface 36 of the top plate extends vertically downward (but not outward) all the way down to the vertically position of the top surface of the magnet. Hence, the geometry of the magnet assembly depicted in FIG. 8b is not according to the present invention. In the present example the different geometries depicted in FIGS. 8a, 8b, 8c and 8d are referred to as geometry A, B, C and D respectively.

For simulation of the flux plots the Applicant has used the program Infolytica MagNet 6.22.

The simulations of flux density and field curves in the air gap were performed with static 2D analysis.

The applicant has supplied geometrical input to the above program. The 2D sketch input was provided in DXF file format exported from SolidWorks 3D models. Variations of the geometry have been changed within MagNet (Shift edges, etc.). Specifically the dimensions of the magnet was Ø90×Ø54×4 mm. The magnet material was N38H, remanence being Br=1.2 Tesla.

Specifically, the air gap was maintained at a height of 20 mm (exception with design geometry B, in which the air gap continues down to the surface of the magnet). The width of the gap is also maintained constant at 2.2 mm to provide sufficient room for voice coil (thickness 1.3 mm) and clearance. Steel material is defined as a specific low carbon steel (max. 0.1%) utilized by the applicant, but comparable to any other low alloy steel, for example JISG3131 SPHC, alternatively use Cold rolled 1010 steel (CR10Loss from MagNet material database).

Suggestion for a MagNet setup:

Solver options
pol. order=2
Newton tol.=0.01%
CG tol.=0.01%
Yes to “improve mesh before solving”

Adaption
Use h-adaption
20% h-adaption
tolerance=0.01%

Curve smoothness=5 (default=18)

Element size=2 (Air element size=5)

Curvature refinement=0.03

### Results

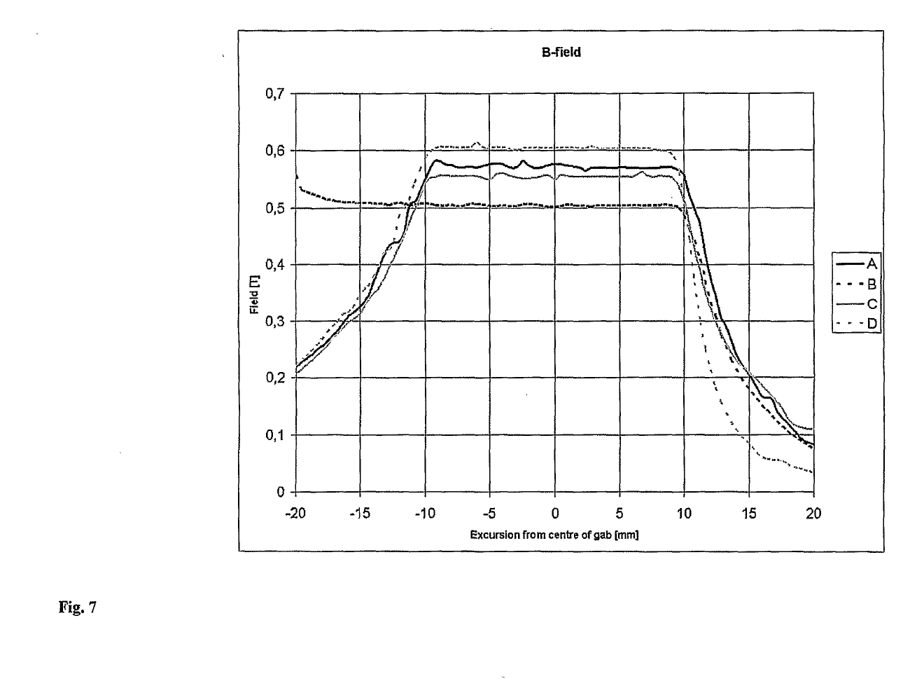

The results of the simulations are shown in FIG. 7. FIG. 7 shows in respect of each of the geometries A, B, C and D, the B field as as a function of the excursion in an axially direction from the centre of the gap. Hence FIG. 7 illustrates in respect of each of the geometries A, B, C and D the strength of the B field in the gap, the homogeneity of the strength of the B field in the gap as well as the degree of symmetry of the roll-off behaviour at either axially end of the gap.

### Geometry D (According to the Present Invention)

In this geometry the top surface 38 of the top plate flushes with the top surface defined by the rim 11 of the T-yoke. FIG. 7 (grey punctured line) shows that this geometry provides for the highest B strength within the gap. However, this high strength comes at the price of a lower symmetry of roll off behaviour outside the gap (cf. the steeper curve at excursion from 10 to 15 mm compared to the curve at excursion from −10 to −15 mm). For high-end applications, this degree of symmetry of the roll-off behaviour is however considered acceptable.

### Geometry A (According to the Present Invention)

This geometry is identical to geometry D with the exception that the pole part of the T-yoke extends axially beyond the extention in an axially direction of the top plate. The effect of this geometry is a slightly lower strength of the B field within the gap (cf. black full line). However, the symmetry of roll off behaviour outside the gap is improved compared to geometry D (less steep curve at excursion from −10 to −15 mm). For high-end applications, the behaviour of geometry A is considered acceptable.

### Geometry C (According to the Present Invention)

This geometry represents an alternative design of the top plate in which the outer surface 50 of the top plate extends vertically upwards (and hence not inwards) from the bottom outer rim 48 to the upper outer rim 52. The effect of this variation is an intermediate result compared to geometry A and D as to strength of the B field in the gap as well as to the roll-off symmetry of the B field outside the gap (cf. grey full line). For high-end applications, the behaviour of geometry C is considered acceptable.

### Geometry B (Not According to the Present Invention)

This geometry represents a design of the top plate in which the upper inner surface 36 of the top plate extends vertically downward (but not outward) all the way down to the vertically position of the top surface of the magnet. This design results in detrimental effects as to the strength of the B field within the gap as well as to the roll-off symmetry outside the gap. In FIG. 7 (black punctured line) it is seen that the strength of the B field witin the gap is the lowest of the four geometries presented. Furthermore, the roll-off behaviour outside the gap is completely unsymmetrical. Such a behaviour is considered highly undesired and unacceptable for high-end application because such an unsymmetrical roll-off behaviour provides for even harmonic distortions in a loudspeaker. Such even harmonic distortions are audible.

1. A magnet assembly (1) for a transducer unit of the type having a moving membrane and having a voice coil arranged into said magnet assembly, said magnet assembly comprising the components i)-iii):
i) a T-yoke (2); and
ii) a magnet system (4); and
iii) a top plate (6);
wherein the T-yoke (2) comprises a body comprising a pole part (8) defining a cylindrical, outer surface (10) which is symmetrical around an axis of rotation, said cylindrical surface has an outer diameter d₁ and a cylinder rim (11); wherein in the orientation in which the axis of rotation of the cylindrical surface (10) is vertical and in which the cylinder rim (11) points upwards, the T-yoke (2) furthermore comprises:
a back plate (12) comprising a bottom surface (14); said bottom surface (14) at its bottom rim (16) extends outwards and upwards so as to define an outer back plate surface (18) which ends in an outer rim (20), wherein said back plate (12) furthermore comprises an accommodation surface (22) for a magnet system, said accommodation surface (22) for a magnet system extending essentially in a horizontal direction inwards from the outer rim (20) to an inner rim (24), wherein said accommodation surface (22) for a magnet system is essentially symmetrical around the axis of rotation of the cylindrical surface (10); and
wherein said magnet system (4) is an annular body having a top surface (26), a bottom surface (28); wherein the top surface (26) is essentially parallel to the bottom surface (28), and wherein the dimensions of the magnet system (4) in the radial direction are adapted so as to be able to fit onto the accommodation surface (22) of the T-yoke (2); and
wherein the top plate (6) comprises an annular body comprising an upper, inner surface (36) which is essentially cylindrical and symmetrical around an axis of rotation, said upper, inner surface (36) extends from an upper, inner rim (38) to a lower, inner rim (40); and said upper, inner surface (36) having a diameter d₂; wherein in the orientation in which the axis of rotation of the cylindrical surface (36) is vertical and in which the rim (38) points upward, the top plate furthermore comprises: a lower, inner surface (42) extending downwards and outwards from the lower, inner rim (40) to a bottom inner rim (44); a bottom surface (46) extending from the bottom inner rim (44) to a bottom, outer rim (48b); said bottom surface (46) being essentially horizontal; an outer surface (50) extending upwards and preferably inwards from a bottom, outer rim (48,48a) to an upper, outer rim (52); and a top surface (54) extending from the upper, outer rim (52) to the upper, inner rim (38); wherein dimensions of the bottom surface (46) are adapted so as to be able to fit onto the top surface (26) of the magnet system (4);
characterised in that the diameter d₁ is smaller than the diameter d₂; and in that the top plate (6) is arranged on top of the magnet system (4) in such a way that the bottom surface (46) of the top plate (6) touches the top surface (26) of the magnet system (4), and in that the magnet system (4) is arranged on top of the T-yoke (8) in such a way that the bottom surface (28) of the magnet system (4) touches the accommodation surface (22) of the T-yoke (8); and in that the difference between the diameter d₁ and d₂ defines a gap (56) between the cylindrical, outer surface (10) of the T-yoke and the upper, inner surface (36) of the top plate so as to be able to accommodate a voice coil and further that the lower, inner surface (42) of the top plate comprises at least a partial surface (42a), said partial surface (42a) defines a curve in such a way that the shortest distance between any point on the surface (42a) and the outer surface (50) in a horizontal direction is essentially constant so as to provide an essentially constant minimum cross sectional area for the magnetic flux in order to maintain at constant flux density.

2. A magnet assembly according to claim 1, characterised in that that the distance ½*(d₂−d₁) is 0.5-3.0 mm, e.g. 0.75-2.0 mm, such as 1.0-1.8 mm.

3. A magnet assembly according to claim 1, wherein the T-yoke and/or the top plate is/are made of a material of a high magnetic permeability, preferably low-alloy steel (soft iron); and/or wherein the body of the magnet system comprises a material of neodymium, ferrite, samarium-cobalt or AlNiCo; or comprises another type of a hard magnetic material.

4. A magnet assembly according to claim 1, wherein the cylindrical, outer surface (10) of the T-yoke in an axial direction extends beyond the extent in an axial direction of the upper, inner surface (36) of the top plate.

5. A magnet assembly according to claim 1, wherein the magnet system (4) is in one piece and comprising an annular body of a magnetic material which annular body comprising a top surface (26), a bottom surface (28), an outer surface (30) and having a central hole (34) defined by an inner surface (32); wherein the inner surface (32) as well as the outer surface (30) are cylindrical; wherein the outer surface (30) and the inner surface (32) are essentially perpendicular to the surfaces (26) and (28).

6. A magnet assembly according to claim 1, wherein the magnet system (4) is a body comprised of an array of disc shaped magnets having identical dimensions and together defining a top surface (26), a bottom surface (28), wherein the centre of each disc shaped magnet of said array is arranged with essentially equal mutual spacing on a circle.

7. A magnet assembly according to claim 1, wherein the extension of the magnet system in a radial direction exceeds the extension in a radial direction of the surface (46) of the top plate and/or exceeds the extension in a radial direction of the accommodation surface (22) of the T-yoke.

8. A magnet assembly according to claim 1 further comprising a fourth component, said fourth component being a booster magnet arranged on top of the pole part (8) of the T-yoke, said booster magnet preferably being a disc shaped magnet which is symmetrical around an axis of rotation.

9. A magnet assembly according to claim 1, wherein the outer surface (50) of the top plate in a direction from a point on the rim (48,48a) to the nearest point on the rim (52) defines a concave curve and/or wherein the lower, inner surface (42) of the top plate in a direction from a point on the rim (44) to the nearest point on the rim (40) defines a concave curve.

10. A magnet assembly according to claim 1, wherein the outer surface (50) of the top plate in a direction from a point on the rim (48,48a) to the nearest point on the rim (52) defines a convex curve and/or wherein the lower, inner surface (42) of the top plate in a direction from a point on the rim (44) to the nearest point on the rim (40) defines a concave curve.

11. A magnet assembly according to claim 1 wherein the lower, inner surface (42) of the top plate comprises at least a partial surface (42a), said partial surface (42a) defines a curve in such a way that the shortest distance between any point on the surface (42a) and the outer surface (50) in a horizontal direction is essentially constant so as to provide an essentially constant minimum cross sectional area for the magnetic flux in order to maintain at constant flux density.

12. A magnet assembly according to claim 1, characterized in that the cylindrical, outer surface (10) of the T-yoke and/or the upper, inner surface (36) of the top plate is provided with a layer of a conductive material, said layer extends axially in a length at least corresponding to the axial length of the gap (56), wherein said conductive layer is preferably selected from the group comprising copper, silver, aluminum, platinum and gold.

13. A magnet assembly according to claim 12, wherein the thickness of the layer is 0.1-0.7 mm, such as 0.15-0.6 mm, for example 0.18-0.32 mm.

14. A magnet assembly according to claim 1, wherein the back plate (12) of the T-yoke (2) and the top plate (6) comprise axially arranged holes which may serve to accommodate bolts for bolting together the assembly and/or may serve as cooling and/or venting channels, wherein said holes preferably are being located on a circle having a diameter which is greater than d₁.

15. A method for the manufacture of a magnet assembly (1) according to claim 1, by assembling a T-yoke (2), a magnet system (4), and top plate (6); wherein the flux density in the gap (56) of the magnet assembly (1) is predetermined by the choice of the extent in an axial direction of the surface (36) of the top plate.

16. Use of a magnet assembly according to claim 1 for the manufacture of a loudspeaker.

17. A loudspeaker comprising a magnet assembly (1) according to claim 1; wherein a voice coil is accommodated into the gap (56) defined by the space between the outer surface (10) of the T-yoke and the upper, inner surface (36) of the top plate; and wherein the magnet assembly (1) is suspended in a chassis and wherein a membrane is suspended between the voice coil and the chassis.

18. A loudspeaker according to claim 17 of the underhung type, wherein the voice coil has an extension in an axial direction which is smaller than the axial extension of the gap (56) defined by the space between the outer surface (10) of the T-yoke and the upper, inner surface (36) of the top plate.

19. A loudspeaker cabinet comprising a loudspeaker according to claim 17.
